(19) United States
(12) Patent Application Publication
(10) Pub. No.: US 2015/0194835 A1
(43) Pub. Date: Jul. 9, 2015

(54) POWER CONTROL OF BATTERIES

(71) Applicant: James P. Wiebe, Wichita, KS (US)

(72) Inventor: James P. Wiebe, Wichita, KS (US)

(21) Appl. No.: 14/555,479

(22) Filed: Nov. 26, 2014

Related U.S. Application Data
(60) Provisional application No. 61/909,253, filed on Nov. 26, 2013.

(51) Int. Cl. H02J 7/00

(52) U.S. Cl. CPC H02J 7/0063; H02J 2007/0067

(57) ABSTRACT

A system for regulating voltage from a battery pack includes a series of cells that forms a battery pack, and a series of electronic switches interspersed among the cells, and in operative communication with them. A controller is in operative communication with the switches to allow selective actuation of each of them.

### FIELD OF INVENTION

The present invention is a methodology for efficiently regulating the voltage coming out of a battery pack, specifically when a series of cells (‘pack’) are connected together to produce an increased voltage, which is in turn used to power an electrical device, such as a motor. A real world example would be a battery pack in an electrical vehicle (‘EV’), which in turn is connected to an electrical motor.

### BACKGROUND

DC electric motors which utilize brushes (‘brushed motor’) are proportionally controlled by the inclusion of a variable voltage regulator, placed in series with the battery pack, usually on the positive supply lead. The variable voltage regulator reduces the voltage as required by the vehicle operator, thus allowing a proportional response to throttle requirements for various speed levels from the brushed motor. A multiplicity of design methodologies exist for these variable voltage regulators; for example, but not limited to: regulators which operate utilizing a switching inductive energy storage device.

Brushless DC electric motors (‘BLDC motor’) are regulated through the timed switching of a multiplicity of magnetic coils, which are included within the design of the BLDC motor. The controllers thereto regulate power in proportional response to throttle requirements by varying the length and phasing of the electrical pulses applied to each coil within the BLDC motor. The controllers are also placed in series to the battery pack, usually on the positive supply lead.

The battery packs obviously must be recharged after usage causes depletion of storage. Invariably, individual batteries vary slightly in their ability to carry a constant charge (or a constant amount of energy). As overcharging may cause catastrophic destruction of the battery, it is critical to battery system designers to implement a methodology which prevents such destruction by stopping the charging of batteries which are already full, while allowing other batteries with greater capacity to continue charging. The impact of this design criteria may also be exacerbated by a similar problem, which is over-discharge. The individual cells within the battery pack must not be over-discharged. Therefore, electronic battery monitoring (‘battery monitoring’) exists which monitors the state of each individual cell while charging, and while discharging. The battery monitoring circuitry is usually a part of battery pack design, and is also usually a part of the EV design.

### SUMMARY

In one embodiment of the present invention, a controller is created that works by interspersing electronic switches throughout the series construction of the battery pack, thus allowing the following features:

1) Batteries which are depleting their total charge more rapidly (due to variance in manufacturing) may be switched out of circuit, so that all batteries are depleted at the same time. In the absence of this feature, the usage of the battery pack must be discontinued when the first cell (whichever cell, of all cells in series in the battery pack) is depleted.

2) If a brushed motor is used, the interspersed electronic switches allow coarse regulation of the motor speed and power by allowing any set of quantity n batteries contained within the battery pack to be dynamically connected in series. For example, a battery pack with a final voltage of 72 volts (obtained by 20 batteries of 3.6 volts, connected in series) may produce any voltage from 3.6 to 72 volts, as batteries are removed and rewired utilizing the interspersed electronic switches.

3) As individual voltages within individual cells start to reduce, as is typical for all battery cells experiencing discharge, the interspersed electronic switches allow dynamic rewiring to add in cells and increasing the total voltage of the battery pack. For example, if 12 cells (out of a series pack of 20 cells) are actively engaged via switching to produce 43.2 volts (12×3.6 volts), then as individual voltages within cells sag, a 13^{th} cell might be added at the calculated moment via the interspersed switches. An example of this sag condition would be when the voltages of the average cell are at 3.32 volts. 13×3.32 volts=43.2 volts, so the dynamic reprovisioning allows the battery pack to be delivering the approximate required voltage without the need for an additional regulator.

### BRIEF DESCRIPTION OF THE DRAWINGS

FIG. 1 shows two battery cells which are connected with interspersed electronic switches.

FIG. 2 is a diagram showing a battery system comprised of N copies of the cells shown in FIG. 1

### DETAILED DESCRIPTION

The present invention provides a method to regulate voltage while ensuring that the total capacity of each battery is utilized.

10) BATTERIES: may be any rechargeable chemistry, including lead acid, nickel cadmium, lithium polymer, etc.

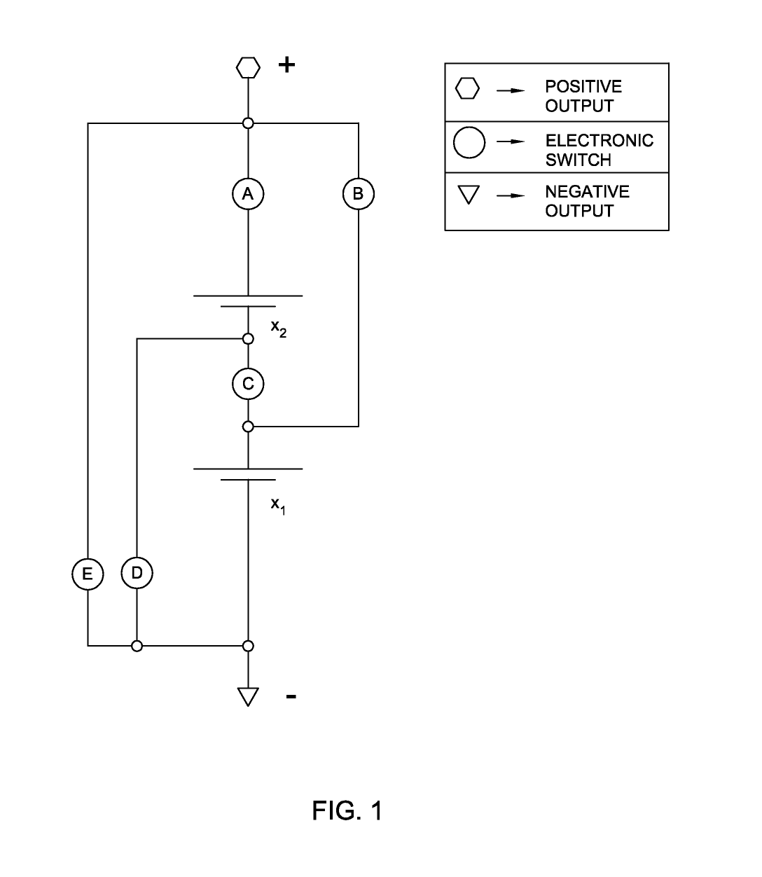

12) ELECTRONIC SWITCHES: although they may be thought of as a simple metal switch, they are optimally constructed from semiconductors, such as MOSFET or other similar or superior switching devices. The MOSFETs receive on/off control from a central control unit. The switching of the MOSFET allows any pair of batteries (as shown in FIG. 1) to be connected individually or serially or bypassed to that pair's output. The ability to switch any battery out of circuit provides key benefits of the present invention: load balancing, direct regulation of output voltage of the battery system without the requirement of additional regulators; control of charging by switching potentially overcharged cells out of circuit.

14) CONTROL: The control module accepts commanded input (from a throttle, for instance) and directs the series of switches present within the interspersed switch arrays to produce an output voltage which is equivalent or similar to the required output power. For instance, if the throttle commands 60% power, the switches will be set up so that 60% of the available power is routed to the output load, typically a DC or BLDC motor. Additionally, the control module analyzes the voltage of each cell and readjusts the switch matrix to remove cells which are more rapidly losing power, and also to adjust the total number of cells so that power may remain approximately constant, even as each individual cell loses voltage potential.

16) THROTTLE: In embodiments of the present invention where the application is for an electric vehicle, such as a car, golf cart, or airplane, this is an input to the control module, which instructs the control module to provide a requested amount of power to the output load.

18) ALARM OUTPUT: an input to the control module, which instructs the control module that an error condition occurs (such as motor over temperature or overspeed)

20) CHARGE INPUT: an input to the control module, which instructs the control module to configure the battery matrix for charging, and also instructs the control module to monitor individual cells for overcharge conditions and switch them out of circuit, as necessary, in order to ensure a balanced charge on each cell.

22) POWER SWITCH: An ON/OFF key, which is an input to the control module, which instructs the control module that the battery matrix may be allowed to provide power to an external load. In an electric vehicle, this would usually be a keyed electronic input, such as from an ignition switch. It may take other forms, such as provided by keyless start systems, or by simple toggle switches. It increases security and safety, by requiring, in one embodiment, a ‘zero’ or ‘idle’ condition on the throttle before the throttle may be advanced further.

24) TOTAL VOLTAGE OUTPUT: Is provided by the control module to inform the operator of the voltage which is maximally available.

26) CURRENT VOLTAGE OUTPUT: Is provided by the control module to inform the operator of the amount of voltage being delivered to the external load. on the outer surface of the foam, such as foam-compatible paint; adhesive vinyl; shrinkable Dacron (or other) fabric; or layer(s) of fiberglass or other surface composite coverings

28) TOTAL POWER OUTPUT: Is provided by the control module to inform the operator of the amount of wattage (power; horsepower) being delivered to the external load.

30) PERCENT REMAINING POWER: Is provided by the control module to inform the operator of the amount of power still remaining in the battery system

32) INDIVIDUAL CELL INFORMATION: Is provided by the control module to inform the operator critical information related to individual cells; for instance: low capacity

34) ALARMS: Are provided by the control module to inform the operator that critical levels of power remain, or that critical conditions exist.

Referring to FIG. 1, two battery cells are shown which are connected with interspersed electronic switches, so that the voltage produced at the positive output may range between 0 volts and the maximum, x₁+x₂. The switches are capable of selecting an ouput voltage which is sourced from either or both cells, or may bypass the cells entirely, thus allowing current to flow from through the output terminals directly through switch “E”. The switch table clearly shows the switch settings to produce the required output. Not shown are signal lines to each electronic switch, nor are the sensing lines to each battery, allowing a microprocessor or other circuit element to make decisions based on measured voltage levels in each cell. Such a combination of two battery cells becomes an element of a larger battery system.

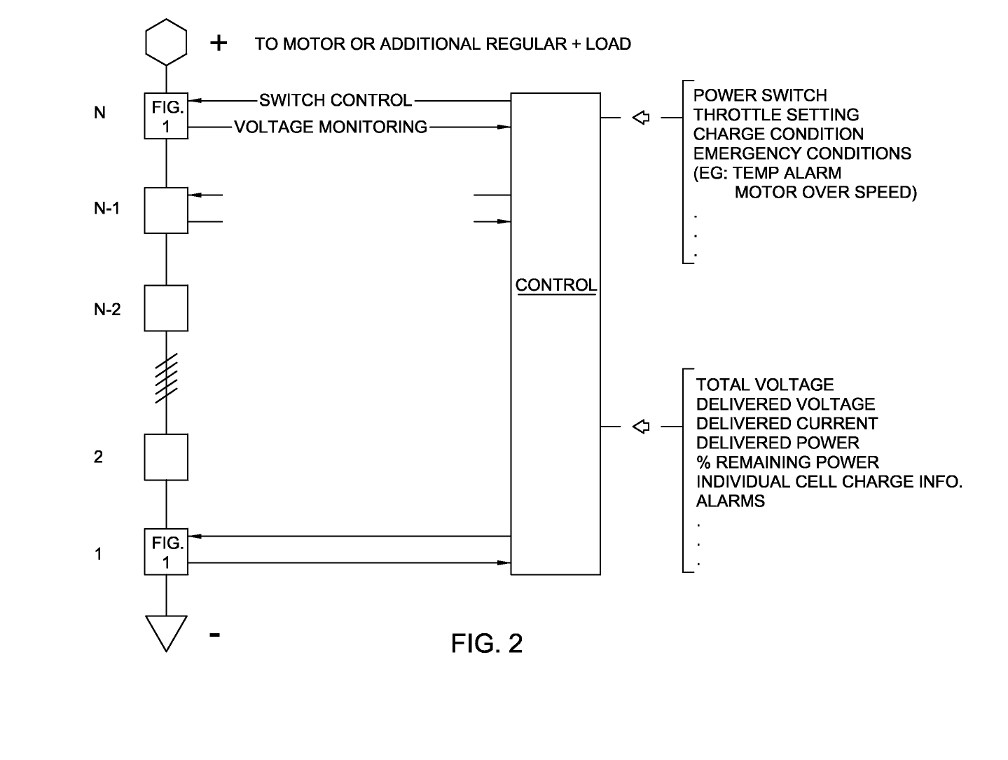

FIG. 2 shows a diagram with a battery system comprised of N copies of cell pair of FIG. 1. (Square boxes on left hand side of FIG. 2.) Each box is comprised of 2 batteries and several switches, as has already been explained. All such N boxes are connected in a serial fashion to produce a positive and a negative voltage, which may be routed directly to a DC motor, or to an additional regulator, in the case of a BLDC motor. The CONTROL box is responsible for analyzing the state of each battery within each FIG. 1 box and setting the condition of switches so that the total voltage, and consequently the total power, may be controlled. The CONTROL box accepts inputs such as throttle setting (via potentiometer or other electronic input), also accepting signal indications that the batteries are being charged, also accepting emergency conditions such as temperature alarms; motor overspeed, etc.

### ALTERNATE DESCRIPTION

The present invention provides a way to build a battery controller for a series of cells, allowing interspersed switches to switch cells in and out of circuits to match power demands, as prompted by an external throttle. The present invention is sufficient to directly control a DC motor without additional circuitry, and will not suffer switching losses as are incurred in conventional voltage controllers which must rely on series voltage regulation techniques. As a result, it is more efficient. Because this improved battery controller also allows all cells within a battery pack to be fully utilized, it will show more total power available to the load per charge cycle, thus increasing cycle power longevity and efficiency.

What is claimed:

1. A system for regulating voltage from a battery pack, comprising:
a series of cells that forms a battery pack;
a series of electronic switches interspersed among the cells, and in operative communication with them; and
a controller in operative communication with the switches to allow selective actuation of each of them.
